(19) United States
(12) Patent Application Publication
(10) Pub. No.: US 2020/0233174 A1
(43) Pub. Date: Jul. 23, 2020

(54) IMAGING BLADE DRIVING DEVICE

(71) Applicant: Nidec Copal Corporation, Tokyo (JP)

(72) Inventors: Kenzo IMAI, Tokyo (JP); Nobuaki WATANABE, Tokyo (JP)

(21) Appl. No.: 16/650,371

(22) PCT Filed: Sep. 21, 2018
(86) PCT No.: PCT/JP2018/035208

§ 371 Date: Mar. 24, 2020

(30) Foreign Application Priority Data
Sep. 28, 2017 (JP) 2017-188736

(51) Int. Cl. G02B 7/02; G03B 9/06

(52) U.S. Cl. CPC G02B 7/021; G03B 9/26; G03B 9/06

(57) ABSTRACT

An imaging blade driving device includes a lens frame holding lenses, and a blade driver mounted on the lens frame including a front frame holding a front lens, a rear frame holding a rear lens and including a step with a larger diameter than the front frame, a pair of slits in a side surface of the front frame along the step, and a connector connecting the front and rear frames outside the slits. The blade driver includes a frame body, and an insert protruding from the frame body and placeable into the slits. The insert has an aperture aligned with an optical axis of the lenses and accommodating a blade. The frame body has a contact surface in contact with a surface of the rear frame perpendicular to an optical axis direction.

### RELATED APPLICATIONS

The present application is National Phase of International Application Number PCT/JP2018/035208, filed Sep. 21, 2018, and claims priority based on Japanese Patent Application No. 2017-188736, filed Sep. 28, 2017.

### FIELD

The present invention relates to an imaging blade driving device including a blade driver mounted on a lens frame.

### BACKGROUND

A known imaging blade driving device includes a lens frame and a blade driver assembled together with an insert (base plates), having an opening and protruding from a driving unit of the blade driver, placed in a slit in a side surface of the lens frame (refer to Patent Literature 1).

In the existing imaging blade driving device, the insert includes a pair of base plates defining a blade chamber to slidably hold diaphragm blades. The insert is placed between multiple lenses held by the lens frame to have its opening aligned with the optical axis of the multiple lenses. The diaphragm blades in the blade chamber are slid by an operation of a driving unit placed outside the lens frame to control the aperture setting.

### CITATION LIST

### Patent Literature

Patent Literature 1: Japanese Unexamined Patent Application Publication No. 2017-40814

### BRIEF SUMMARY

### Technical Problem

To improve the operability of such an imaging blade driving device in assembling the lens frame and the blade driver, the thin insert protruding from the driving unit of the blade driver is to be smoothly placeable into the slit in the side surface of the lens frame without causing bending stress on the insert.

In response to the above issue, one or more aspects of the present invention are directed to a technique for improving the assembling operability of an imaging blade driving device by smoothly placing an insert accommodating blades of a blade driver into a slit in a side surface of a lens frame holding multiple lenses.

### Solution to Problem

In response to the above issue, the device according to one or more aspects of the present invention has the structure described below.

An imaging blade driving device includes a lens frame holding a plurality of lenses, and a blade driver mounted on the lens frame. The lens frame includes a front frame holding at least one front lens among the lenses, a rear frame holding at least one rear lens among the lenses and including a step having a larger diameter than the front frame, a pair of slits in a side surface of the front frame along the step, and a connector connecting the front frame and the rear frame at positions outside the slits. The blade driver includes a frame body, and an insert protruding from the frame body placeable into the slits. The insert has an aperture aligned with an optical axis of the lenses and accommodating a blade. The frame body has a contact surface in contact with a surface of the rear frame perpendicular to a direction of the optical axis.

### BRIEF DESCRIPTION OF DRAWINGS

FIG. 1A is a plan view of an imaging blade driving device according to an embodiment of the present invention, and FIG. 1B is a front view of the imaging blade driving device.

FIG. 2A is a plan view of the imaging blade driving device according to the embodiment of the present invention with a lens frame and a blade driver separate from each other, and FIG. 2B is a cross-sectional view taken along line X1-X1.

FIG. 3 is a cross-sectional view of the imaging blade driving device according to the embodiment of the present invention with the blade driver mounted on the lens frame.

FIG. 4A is a plan view of an imaging blade driving device according to another embodiment of the present invention, and FIG. 4B is a cross-sectional view taken along line X2-X2.

FIG. 5A is a plan view of an imaging blade driving device according to another embodiment of the present invention, and FIG. 5B is a cross-sectional view taken along line X3-X3.

FIG. 6 is an exploded perspective view of a blade driver showing its internal structure.

FIG. 7 is a schematic diagram of the blade driver showing the lens interval and the dimensions of an insert.

FIG. 8 is a schematic diagram of an imaging device including an imaging blade driving device according to an embodiment of the present invention.

FIG. 9 is a schematic diagram of a mobile electronic device (mobile information terminal) including an imaging device including an imaging blade driving device according to an embodiment of the present invention.

### DETAILED DESCRIPTION

Embodiments of the present invention will now be described with reference to the drawings. Hereafter, the components with the same function in different figures are given the same reference numerals, and will not be described repeatedly.

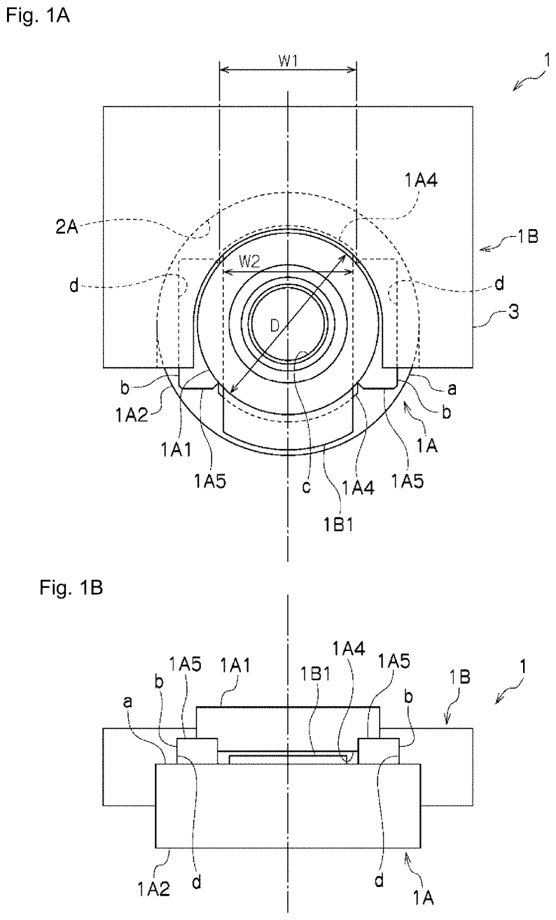

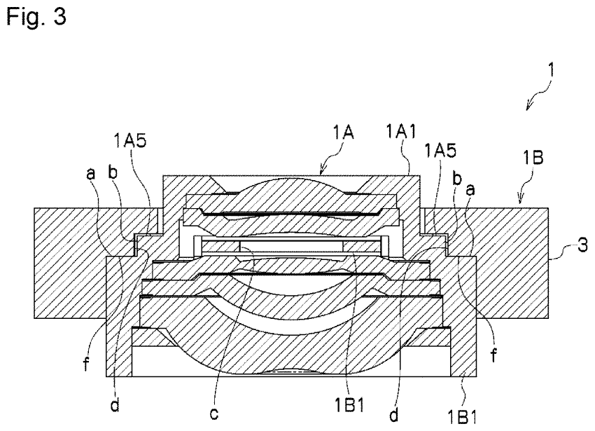

As shown in FIGS. 1A to 3, an imaging blade driving device 1 includes a lens frame 1A and a blade driver 1B mounted on the lens frame 1A. The lens frame 1A holds multiple lenses L1, L2, L3, L4, and L5, and includes a front frame 1A1 for holding front lenses (lens group) L1 and L2, a rear frame 1A2 for holding rear lenses (lens group) L3, L4, and L5, a pair of slits 1A3 and 1A4, and a connector 1A5 for connecting the front frame 1A1 and the rear frame 1A2 outside the pair of slits 1A3 and 1A4.

The rear frame 1A2 of the lens frame 1A includes a step a having a larger diameter than the front frame 1A1. The step a has a support surface perpendicular to the optical axis of the lenses. The slits 1A3 and 1A4 of the lens frame 1A are formed in the side surface of the front frame 1A1 along the step a. The connector 1A5 has a pair of guide surfaces b parallel to a direction of placement into the slits 1A3 and 1A4.

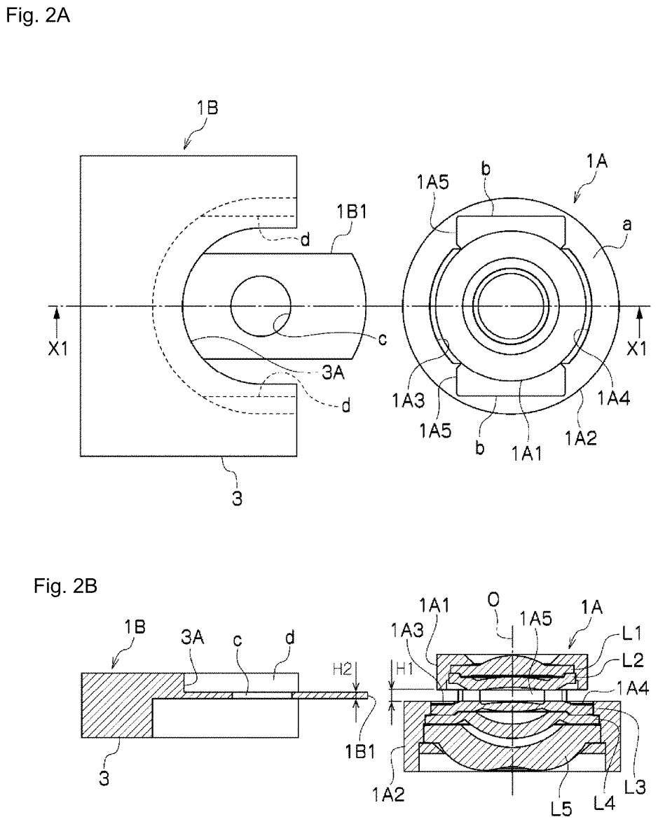

The blade driver 1B includes a frame body 3 and an insert 1B1 protruding from the frame body 3 placeable into the slits 1A3 and 1A4. The insert 1B1 has an aperture c aligned with an optical axis O of the lenses L1 to L5, and accommodates blades. The frame body 3 has a pair of guide surfaces d to be guided by the guide surfaces b, and a contact surface f in contact with a support surface of the step a. The frame body 3 also has a recess 3A for receiving a part of the lens frame 1A. The insert 1B1 protrudes into the recess 3A. The cross-sectional view in FIG. 2B does not show the internal structures of the frame body 3 and the insert 1B1.

In the imaging blade driving device 1, the blade driver 1B is mounted on the lens frame 1A with the insert 1B1 of the blade driver 1B placed in the pair of slits 1A3 and 1A4 of the lens frame 1A.

The contact surfaces f of the frame body 3 of the blade driver 1B come into contact with the support surface of the step a of the lens frame 1A to allow placement of the insert 1B1 into the slits 1A3 and 1A4 with the blade driver 1B remaining perpendicular to the optical axis O. Thus, the insert 1B1 is smoothly placeable into the slits 1A3 and 1A4.

The lens frame 1A also has the pair of guide surfaces b parallel to the direction of placement into the slits 1A3 and 1A4. The blade driver 1B has the pair of guide surfaces d guided by the guide surfaces b. Thus, the guide surfaces d are slid over the guide surfaces b while being guided by the guide surfaces b. This allows smoother placement of the insert 1B1 into the slits 1A3 and 1A4. The guide surfaces b and the guide surfaces d may or may not be in contact with each other during the insertion.

The lens frame 1A includes the slit 1A3 with a width (inlet width) W1 larger than half the outside diameter D of the front frame 1A1 (W1>2×D/2). With the width W1 at least larger than a width W2 of the insert 1B1, the wide slit 1A3 can receive the insert 1B1 without causing contact on its internal surface.

More specifically, W>C+0.5, where W (mm) is the width of the insert 1B1, and C (mm) is the diameter of the aperture c in the insert. The insert 1B1 with a width sufficiently larger than the diameter of the aperture c increases the strength of the insert 1B1, and reduces, for example, deformation of the insert 1B1 during placement.

In the lens frame 1A, the center position between the pair of guide surfaces b corresponds to the center position of the slit 1A3. In the blade driver 1B, the center position between the pair of guide surfaces d corresponds to the center position of the insert 1B1. Thus, the insert 1B1 of the blade driver 1B is placed at the center of the slit 1A3 of the lens frame 1A while the guide surfaces d of the blade driver 1B are in contact with the guide surfaces b of the lens frame 1A. The guide surfaces b and the guide surfaces d may or may not be constantly in contact with each other.

The slit 1A3 has a height (inlet height) H1 smaller than twice a thickness H2 of the insert 1B1. With the height H1 of the slit 1A3 larger than the thickness H2 of the insert 1B1, H2<H1<2×H2. The height H1 of the slit 1A3 can thus be sized to allow smooth placement of the insert 1B1 into the slit 1A3 and reduce light entry into the lens frame 1A through the slit 1A3.

The contact surfaces f of the frame body 3 of the blade driver 1B are supported by the support surface of the step a of the lens frame 1A. The blade driver 1B is thus held perpendicular to the optical axis O not only during placement of the insert 1B1 into the slits 1A3 and 1A4 but also after the placement. Thus, the aperture c in the insert 1B1 can be arranged perpendicular to the optical axis O to adjust the amount of light as appropriate.

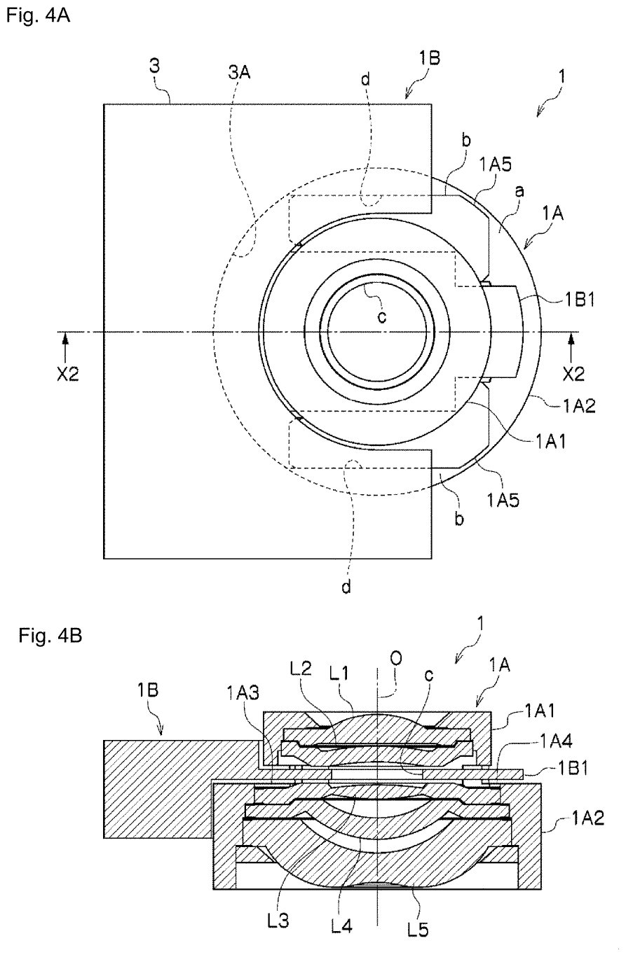

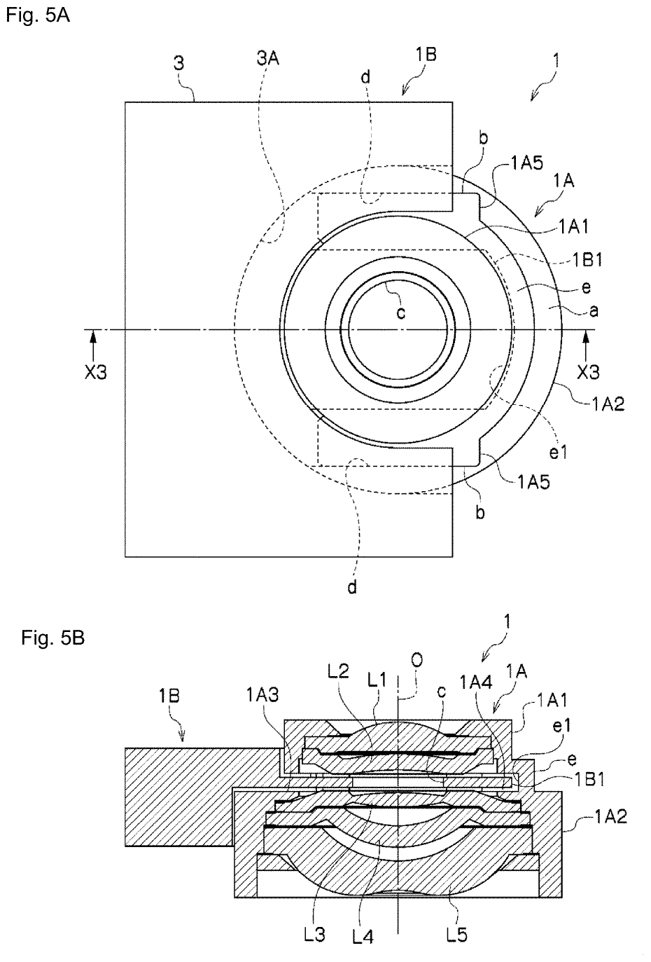

FIGS. 4A, 4B, 5A and 5B show an imaging blade driving device 1 according to another embodiment. In the imaging blade driving device 1 illustrated in FIGS. 4A and 4B, the width W3 of the slit 1A4 at an outlet is smaller than the width W1 of the slit 1A3 at an inlet. The narrower slit 1A4 receives the distal end of the insert 1B1, which has a width narrower toward the distal end. The slit 1A4 at the outlet having the width W3 sized in this manner can rigidly fix the position of the insert 1B1 placed in the slit 1A4 while allowing smooth placement of the insert 1B1 into the slit 1A3 at the inlet in accordance with the relationship between the width W3 of the slit 1A4 and the distal end width of the insert 1B1.

The imaging blade driving device 1 shown in FIGS. 5A and 5B includes a cover e outside the slit 1A4 to avoid exposure of the distal end of the insert 1B1. The cover e includes a holder e1 for holding the distal end of the insert 1B1. The cover e with this structure can reduce entry of light into the lens frame 1A through the slit 1A4, and rigidly fix the position of the placed insert 1B1 with the holder e1 holding the distal end of the insert 1B1.

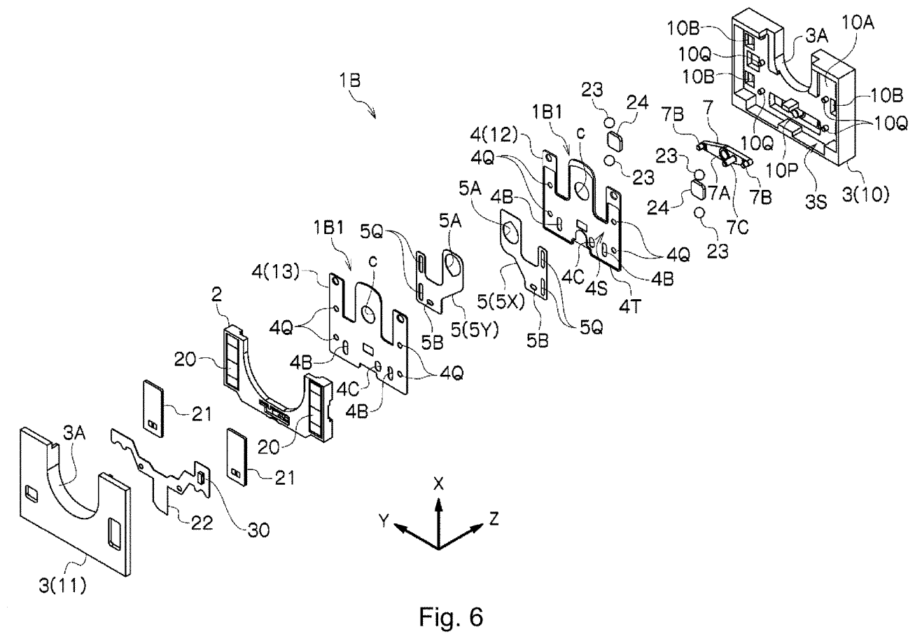

FIG. 6 shows the internal structure of the blade driver 1B. In the figure, arrow Z indicates an optical axis direction (thickness direction of a blade driver), arrow X indicates a blade movement direction, and arrow Y indicates the direction orthogonal to the X- and Y-directions.

The blade driver 1B includes a driving member 2, a frame body 3, a blade supporter 4, and blades 5 (5X and 5Y). The frame body 3 includes a base frame 10 and a cover frame 11 covering the base frame 10, and has a driving frame chamber 3S for accommodating the driving member 2. The driving member 2 is movably supported on a support surface 10A of the base frame 10, and moves on the support surface 10A to move the blades 5 (5X and 5Y).

Magnets 20 and coils 21 are attached to the driving member 2 and the frame body 3 to serve as a driving source. In the example shown in FIG. 6, the magnets 20 are attached to the driving member 2, and the coils 21 are attached to the frame body 3 (cover frame 11). The coils 21 are energized through a wiring board (flexible board) 22 to reciprocate the driving member 2 in X-direction in the drawing. The driving member 2 is movably supported with bearings 23, which are supported in support grooves 10B on the support surface 10A. A Hall element (sensor) 30, which detects the movement of the driving member 2 or the blades 5 (5X and 5Y), is located on the wiring board 22 to correspond to the magnets 20.

The blades 5 (5X and 5Y) are connected to the driving member 2 directly or with a connecting member 7. In the example shown in FIG. 6, the connecting member 7 is pivotally supported in the frame body 3. The connecting member 7 has a pivotal portion 7A at the center pivotally supported by a shaft 10P of the base frame 10, connecting portions 7B, on both ends, extending through long holes 4B in the blade supporter 4 and received in connecting holes 5B in the blades 5X and 5Y, and a connecting portion 7C near the center extending through a long hole 4C in the blade supporter 4 and connected to the driving member 2. In this structure, in response to linear reciprocation of the driving member 2 in the X-direction, the connecting member 7 rotates about the shaft 10P, and causes the blades 5X and 5Y connected to the connecting portions 7B to move away from each other in the X-direction.

The blades 5 (5X and 5Y) are supported by the blade supporter 4. The blade supporter 4 includes a pair of blade support plates 12 and 13 that are thin metal plates. The blade support plates 12 and 13, which are a pair of thin metal plates, have peripheral steps 4T bonded together to define a blade chamber 4S for accommodating the blades 5 (5X and 5Y).

The blade supporter 4 has an aperture c in the insert 1B1 about the optical axis extending in the thickness direction (Z-direction in the drawing) of the frame body 3. The blades 5 (5X and 5Y) are moved over the aperture c by the driving member 2. In the example shown in the drawing, the blades 5 (5X and 5Y) each have an aperture SA, and move in X-direction in the drawing to adjust the degree of an overlap of the apertures SA in the aperture c.

More specifically, protrusions 10Q on the base frame 10 are fitted into holes 4Q in the blade supporter 4 to engage the blade supporter 4 with the base frame 10. The protrusions 10Q are also received in guide holes (long holes) 5Q in the blades 5 (5X and 5Y) supported by the blade supporter 4 to guide the movement of the blades 5 (5X and 5Y). Magnetic members 24 are located in the frame body 3 (base frame 10) to hold the blades 5 at the initial position and to attract the driving member 2 to the base frame 10 in the optical axis direction.

In the example shown in FIG. 6, the blade driver 1B serves as a beam limiting device that adjusts the amount of light passing through the aperture c. Rotation of the connecting member 7 with the movement of the driving member 2 reduces the area of the aperture from a full open state of the aperture c as the degree of overlap of the apertures SA in the aperture c changes. Although the beam limiting device is used in the illustrated example, the blade driver 1B may serve as a shutter device that blocks light passing through the aperture c by fully closing the aperture c with the overlap of the blades 5 (5X and 5Y) as light-shielding blades, or may serve as a filter device including the blades 5 (5X and 5Y) including a filter that restricts the wavelength or amount of light attached at the edges of the apertures SA as an optical filter. The blades 5 may be driven continuously or stepwise.

The blade driver 1B may have an internal structure other than that shown in FIG. 6. For example, the magnets 20 and the coils 21 may be arranged differently, or the number of components may be different.

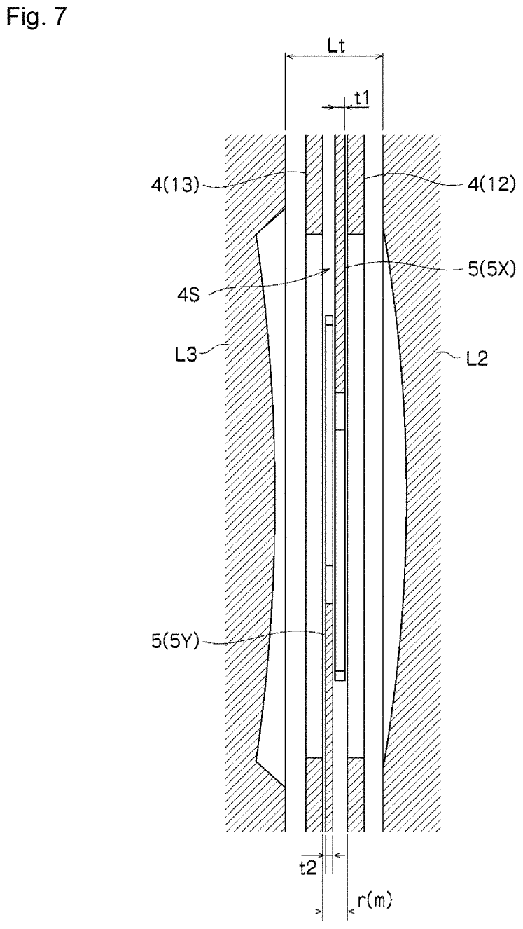

FIG. 7 shows the thickness of the internal components of the insert 1B1 of the blade driver 1B in the optical axis direction, and the interval of lenses between which the insert 1B1 is placed. The imaging blade driving device 1 including the insert 1B1 of the blade driver 1B between two lenses is designed to minimize the lens interval in optical designing of a lens group. However, to allow placement of the insert 1B1, the imaging blade driving device 1 may be designed to optimize the lens interval and the thickness of internal components of the insert 1B1 in the optical axis direction.

As shown in FIG. 7, the dimensions may satisfy the following relationship where Lt is the lens interval between a front lens L2 and a rear lens L3 between which the insert 1B1 is placed, t1 and t2 are the thicknesses of two blades 5 (5X and 5Y) in the optical axis direction, and t1, t2, and t3 are the thicknesses of the three blades 5 in the optical axis direction, and r is the space width of the blade chamber 4S in the optical axis direction:

2×r≤Lt, 3×r>Lt, and 2×t1≤Lt, for the structure including one blade 5 (with thickness t1);

2×r≈Lt, and 2×(t1+t2)≈r, for the structure including two blades 5 (with the respective thicknesses t1 and t2); and

2×r>Lt, and 2×(t1+t2+t3)≥r, for the structure including three blades 5 (with the respective thicknesses t1, t2, and t3).

In the structure including, instead of the blades 5, an optical filter held between two protection blades, 2×r>Lt, and 2×(a total thickness of the filter and the protection blades)>r in some embodiments.

In the structure including the blade chamber 4S with an intermediate member between a pair of blade support plates, a thickness m of the intermediate in the optical axis direction corresponds to a space width r of the blade chamber 4S in the optical axis direction. Thus, the above relationship can be rewritten as follows:

2×m≤Lt, 3×m>Lt, and 2×t1≤Lt, for the structure including one blade 5 (with thickness t1);

2×m≈Lt, and 2×(t1+t2)≈m, for the structure including two blades 5 (with the respective thicknesses t1 and t2); and

2×m>Lt, and 2×(t1+t2+t3)≥m, for the structure including three blades 5 (with the respective thicknesses t1, t2, and t3).

In the structure including, instead of the blades 5, an optical filter held between two protection blades, 2×m>Lt, and 2×(a total thickness of the filter and the protection blades)>m in some embodiments.

The above relationship among the thicknesses t1, t2, and t3 of the blades 5 in the optical axis direction, the space width r (m) of the blade chamber 4S in the optical axis direction, and the lens interval Lt set for placement of the insert 1B1 allows smooth placement of the insert 1B1 between the lenses L2 and L3 and smooth operation of the blades 5 in the blade chamber 4S inside the insert 1B1.

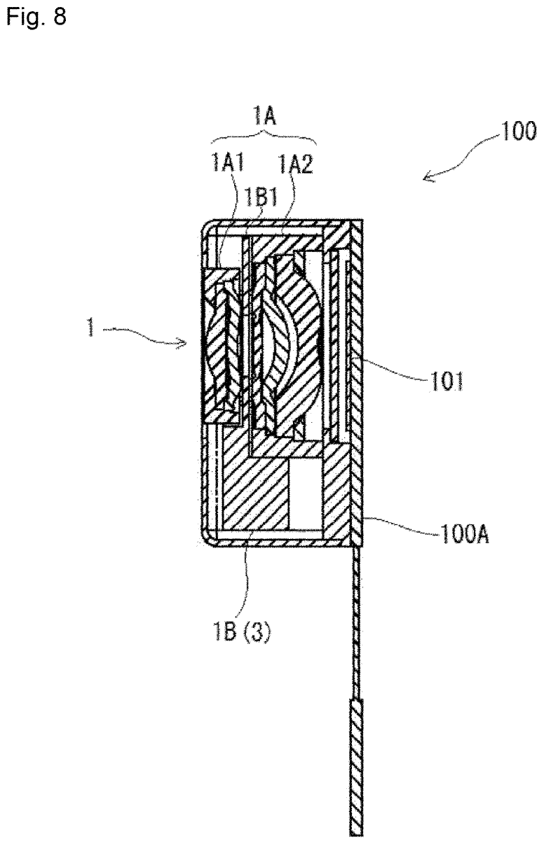

FIG. 8 shows an imaging device 100 serving as an optical unit including the imaging blade driving device 1. As described above, the blade driver 1B is mounted on the lens frame 1A, and the assembly is mounted on a housing 100A on which an image sensor 101 is mounted to form the imaging device 100. The blade driver 1B mounted on another optical component can form a different optical unit. The imaging device 100 or the optical unit can be thinned for saving an installation space in the optical axis direction. The blade driver 1B can be mounted on the lens frame 1A or other components subjected to an adjustment to form an integrated unit, and allows simple and accurate adjustments and simplifies the assembly.

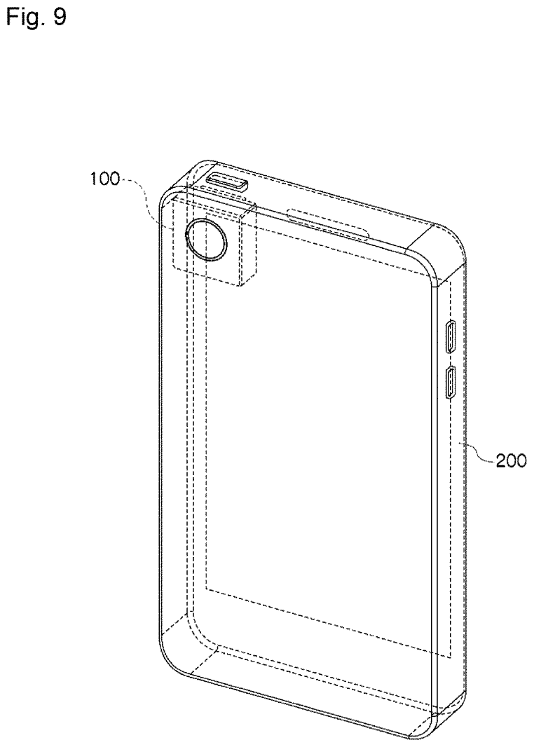

FIG. 9 shows a mobile electronic device (mobile information terminal) 200 including the above imaging device 100. The mobile electronic device 200 such as a smartphone can have an internal unit with a limited thickness. In contrast, the imaging device 100 described above includes the blade driver 1B accommodated in and mounted on the lens frame 1B within the thickness of the lens frame 1A to reduce the thickness and can be mounted in a space-efficient manner on the mobile electronic device 200 with high portability or design qualities. The components inside the frame body 3 according to the embodiment are arranged in position or designed to allow sequential assembly from one side of the base frame 10.

Although the embodiments of the present invention have been described in detail with reference to the drawings, the specific structures are not limited to the above embodiments. The present invention may be modified in design without departing from the spirit and scope of the present invention. Particularly, in the above embodiments, the frame body 3 and the blade supporter 4 are separate components in the blade driver 1B. However, the frame body 3 and the blade supporter 4 may be integral with a space partitioned into a driving frame chamber 3S in the frame body 3 and a blade chamber 4S in the blade supporter 4.

1. An imaging blade driving device, comprising:
a lens frame holding a plurality of lenses; and
a blade driver mounted on the lens frame,
the lens frame including
a front frame holding at least one front lens among the lenses,
a rear frame holding at least one rear lens among the lenses and including a step having a larger diameter than the front frame,
a pair of slits in a side surface of the front frame along the step, and
a connector connecting the front frame and the rear frame at positions outside the slits,
the blade driver including
a frame body, and
an insert protruding from the frame body placeable into the slits, the insert having an aperture aligned with an optical axis of the lenses and accommodating a blade,
wherein the frame body has a contact surface in contact with a surface of the rear frame perpendicular to a direction of the optical axis.

2. The imaging blade driving device according to claim 1, wherein
the connector has a pair of guide surfaces parallel to a direction of placement into the slits, and
the frame body has guide surfaces to be guided by the guide surfaces in placement of the insert into the slits.

3. The imaging blade driving device according to claim 1, wherein
one of the slits at an inlet has a width larger than half an outside diameter of the front frame.

4. The imaging blade driving device according to claim 1, wherein
a width W of the insert in millimeters and a diameter C of the aperture in millimeters have a relationship of W>C+0.5.

5. The imaging blade driving device according to claim 1, wherein
one of the slits at an inlet has a height smaller than twice a thickness of the insert.

6. The imaging blade driving device according to claim 1, wherein
one of the slits at an outlet has a width smaller than a width of another slit at an inlet.

7. The imaging blade driving device according to claim 1, wherein
one of the slits at an outlet is covered by a cover to avoid exposure of a distal end of the insert, and
the cover includes a holder inside to hold the distal end of the insert.

8. The imaging blade driving device according to claim 1, wherein
2×r≤Lt, 3×r>Lt, and 2×t1≤Lt, for the imaging blade driving device including a first blade in the insert,
2×r≈Lt, and 2×(t1+t2)≈r, for the imaging blade driving device including a first blade and a second blade in the insert, and
2×r>Lt, and 2×(t1+t2+t3)≥r, for the imaging blade driving device including a first blade, a second blade, and a third blade in the insert,
where Lt is a lens interval between the at least one front lens and the at least one rear lens between which the insert is placed, t1 is a thickness of the first blade, t2 is a thickness of the second blade, t3 is a thickness of the third blade each in the optical axis direction, and r is a space width of a blade chamber in the insert in the optical axis direction.

9. The imaging blade driving device according to claim 1, wherein
the blade is a light-shielding blade.

10. The imaging blade driving device according to claim 1, wherein
the blade is a diaphragm blade configured to adjust an amount of light.

11. The imaging blade driving device according to claim 1, wherein
the blade includes an optical filter.

12. The imaging blade driving device according to claim 11, wherein
the optical filter includes a filter held between two protection blades, and
2×r>Lt, and 2×(a total thickness of the filter and the protection blades)>r, where Lt is a lens interval between the at least one front lens and the at least one rear lens between which the insert is placed, and r is a space width of a blade chamber in the insert in the optical axis direction.

13. The imaging blade driving device according to claim 1, wherein
the blade driver drives the blade stepwise or continuously.

14. An imaging device, comprising:
the imaging blade driving device according to claim 1.

15. A mobile electronic device, comprising:
the imaging blade driving device according to claim 1.
